(19) United States
(12) Patent Application Publication
(10) Pub. No.: US 2023/0125287 A1
(43) Pub. Date: Apr. 27, 2023

(54) SYSTEMS AND METHODS FOR UNFOLDING DATA ENTRY FORMS FOR BI-DIRECTIONAL LEARNING

(71) Applicant: Ent. Services Development Corporation LP, Houston, TX (US)

(72) Inventors: Keith R. BUCK, Bloomfield, IN (US); Robert E. CAMPBELL, Fort Collins, CO (US)

(21) Appl. No.: 17/856,286

(22) Filed: Jul. 1, 2022

Related U.S. Application Data
(63) Continuation of application No. 17/118,336, filed on Dec. 10, 2020, now abandoned.
(60) Provisional application No. 62/945,987, filed on Dec. 10, 2019.

(51) Int. Cl. G06Q 10/10; G06Q 10/101; G06F 40/18

(52) U.S. Cl. CPC G06Q 10/103; G06Q 10/101; G06F 40/18

(57) ABSTRACT

Various embodiments of the present technology can include systems, methods, and non-transitory computer readable media configured to receive milestones to define objects and attributes associated with the objects. The objects and the attributes can define an architecture of a system. A first table associated with a first milestone can be provided. The first table can be configured to receive a first set of objects associated with the first milestone. The first set of objects and a corresponding set of attributes for the first set of objects can be received. An indication to advance to a second milestone that follows the first milestone can be received. A second table associated with the second milestone can be provided. The second table can be configured to receive a second set of objects associated with the second milestone.

### CROSS-REFERENCE TO RELATED APPLICATIONS

This application is a non-provisional of and claims priority to U.S. Patent Provisional Application No. 62/945,987, filed on Dec. 10, 2019 and entitled “SYSTEMS AND METHODS FOR UNFOLDING DATA ENTRY FORMS FOR BI-DIRECTIONAL LEARNING,” all of which is incorporated in its entirety herein by reference.

### FIELD OF THE INVENTION

The present technology relates to the field of system architecture. More particularly, the present technology relates to generation, configuration, visualization, and learning of the system architecture.

### BACKGROUND

Understanding security of a system architecture can involve a complex bi-directional learning process where a security expert must learn about a product from product team members and the product team members must learn about security concerns from the security expert based on the learning of the security expert. For example, the security expert might interview a team member to learn about a system architecture, starting with components and moving to interfaces that connect a component with another component only to determine there are other components that were not discussed. Similarly, the security expert might ask about data handled through the interfaces only to find there are unaccounted for interfaces. Thus, the conventional approaches are ad hoc processes that are prone to error and wasteful of resources. As a system architecture becomes increasing complex, the ad hoc processes quickly become impractical and potentially provide more error. Further, security experts often approach designing a secure architecture with methodologies that are most convenient or intuitive for them. Unfortunately, the methodologies that the security expert use may not be easily comprehensible to the team members. Thus, knowledge transfers among the security expert and team members can be suboptimal at best.

### SUMMARY

Various embodiments of the present technology can include systems, methods, and non-transitory computer readable media configured to receive milestones to define objects and attributes associated with the objects. The objects and the attributes can define an architecture of a system. A first table associated with a first milestone can be provided. The first table can be configured to receive a first set of objects associated with the first milestone. The first set of objects and a corresponding set of attributes for the first set of objects can be received. An indication to advance to a second milestone that follows the first milestone can be received. A second table associated with the second milestone can be provided. The second table can be configured to receive a second set of objects associated with the second milestone.

In an embodiment, at least one row or column in the first table can be specified to be visually hidden during the first milestone.

In an embodiment, a third table can specify the first milestone, the second milestone, and the at least one row or column that is specified to be hidden during the first milestone.

In an embodiment, at least one row or column can be made visible in the first table after receiving an indication to advance to a third milestone that follows the second milestone.

In an embodiment, at least one object of the second set of objects associated with the second milestone can be provided as selectable options. The selectable options can be attributes that describe the first set of objects in the first table.

In an embodiment, an object of the first set of objects or the second set of objects can be at least one of a component of a system, a zone in which the component is included, or an interface that connects the component to another component within the system.

In an embodiment, an existence of the other component can be inferred based on the interface that connects the component to the other component. The other component can be added to the first table based on the inferring the existence of the other component.

In an embodiment, at least one attribute associated with the component can be populated based on the interface that connects the component to the other component.

In an embodiment, a cell of the first table can be formatted to indicate a missing, improper, or conflicting object or attribute.

In an embodiment, an indication to generate a system diagram based on the first set of objects and the second set of objects can be received. A visual diagram or a description of the visual diagram can be generated.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including a system architecture definition module, according to an embodiment of the present technology.

FIG. 2 illustrates an example milestone management module, according to an embodiment of the present technology.

FIGS. 3A-3F illustrate an example scenario associated with unfolding data entry forms for bi-directional learning, according to an embodiment of the present technology.

FIG. 4A illustrates an example visualization of a system architecture, according to an embodiment of the present technology.

FIG. 4B illustrates an example extensible markup language (XML) schema associated with a system architecture, according to an embodiment of the present technology.

FIG. 4C illustrates another example visualization of a system architecture, according to an embodiment of the present technology.

FIG. 5 illustrates a flowchart of an example method associated with unfolding data entry forms for bi-directional learning, according to an embodiment of the present technology.

FIG. 6 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Understanding security of a system architecture can involve a complex bi-directional learning process where a security expert must learn about a product from product team members and the product team members must learn about security concerns from the security expert based on the learning of the security expert. For example, the security expert might interview a team member to learn about a system architecture, starting with components and moving to interfaces that connect a component with another component only to determine there are other components that were not discussed. Similarly, the security expert might ask about data handled through the interfaces only to find there are unaccounted for interfaces. Thus, the conventional approaches are ad hoc processes that are prone to error and wasteful of resources. As a system architecture becomes increasing complex, the ad hoc processes quickly become impractical and potentially provide more error. Further, security experts often approach designing a secure architecture with methodologies that are most convenient or intuitive for them. Unfortunately, the methodologies that the security expert use may not be easily comprehensible to the team members. Thus, knowledge transfers among the security expert and team members can be suboptimal at best.

Another drawback of the conventional approaches is that conventional approaches do not provide adequate means to consider the security impact of a product or application. A security expert collects product data about components, interfaces, network domains, data security characteristics, or the like from team members to better determine security risks. The security expert assists product team members to understand the security impact of their decisions as the security expert learns more about the product data. However, some advice of the security expert can undesirably impact business needs addressed by the product or application if the advice is provided out of proper context.

An improved approach rooted in computer technology overcomes the foregoing and other disadvantages associated with conventional approaches specifically arising in the realm of computer technology. Based on computer technology, the present technology provides improved techniques of unfolding data entry forms for bi-directional learning. More particularly, the present technology can provide a sequential and linear learning process that gradually unfolds a complex system architecture into steps defined by a security expert. The present technology can transform the conventional ad hoc learning process into a defined sequence of steps (e.g., milestones) which can be separate from iterative data gathering processes. The defined sequence of steps can help users of the present technology to gradually and systematically understand relevant concepts while keeping the concepts at the right level of depth. The present technology can collect different types of data while gradually defining a system architecture with that data. During the unfolding, the present technology can start with a simple representation and then gradually and selectively add complexity. The present technology can enable a security expert and project members to easily identify proper context and eliminates a need to iteratively collect data about architectural elements.

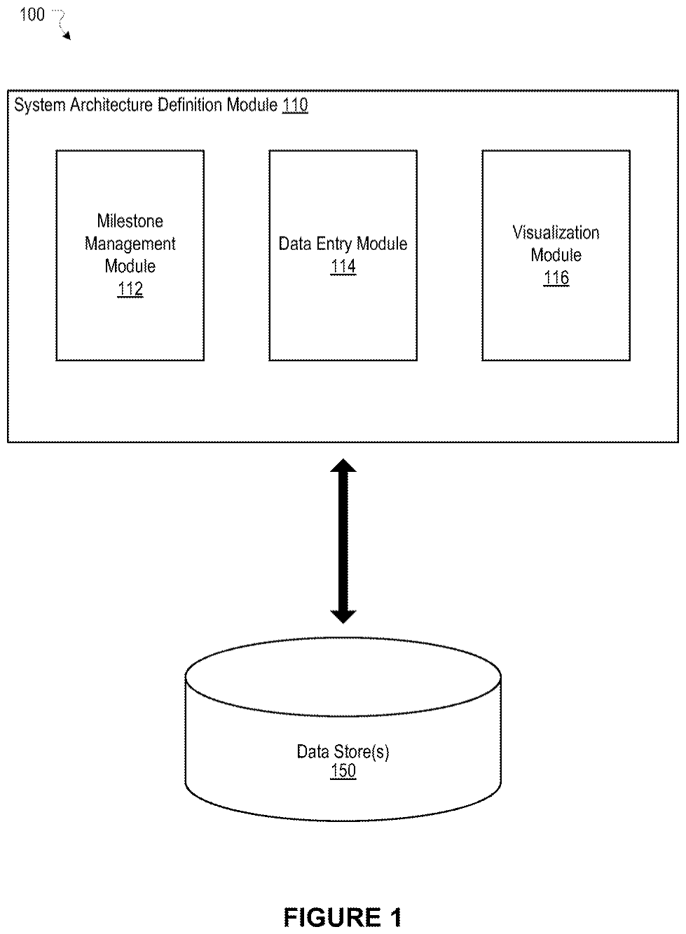

FIG. 1 illustrates an example system 100 including a system architecture definition module 110, according to an embodiment of the present technology. The system architecture definition module 110 can be configured to unfold various data entry forms based on milestones. For example, the system architecture definition module 110 can provide data entry forms for various types of components, trust zones, interfaces, or the like that are associated with a system architecture. Each data entry form can be associated with a milestone. The data entry forms can be incrementally unfolded to allow access to an increased number of types of objects and/or allow data entry of an increased number of attributes for the objects based on progression through the milestones. The system architecture definition module 110 can make accessible more definable objects, attributes, associations, or the like at each milestone. Objects and attributes that defined during previous milestones can be provided as candidate objects and attributes in subsequent milestones.

As shown in FIG. 1, the system architecture definition module 110 can include a milestone management module 112, a data entry module 114, and a visualization module 116. It should be noted that the components (e.g., modules) shown in this figure and all figures herein are exemplary only, and other implementations may include additional, fewer, integrated or different components. Some components may not be shown so as not to obscure relevant details.

In some embodiments, the various modules and/or applications described herein can be implemented, in part or in whole, as software, hardware, or any combination thereof. In general, a module and/or an application, as discussed herein, can be associated with software, hardware, or any combination thereof. In some implementations, one or more functions, tasks, and/or operations of modules and/or applications can be carried out or performed by software routines, software processes, hardware, and/or any combination thereof. In some cases, the various modules and/or applications described herein can be implemented, in part or in whole, as software running on one or more computing devices or systems, such as on a user or client computing device or on a server. For example, one or more modules and/or applications described herein, or at least a portion thereof, can be implemented as or within an application (e.g., app), a program, or an applet, etc., running on a user computing device or a client computing system. In another example, one or more modules and/or applications, or at least a portion thereof, can be implemented using one or more computing devices or systems that include one or more servers, such as network servers or cloud servers. It should be understood that there can be many variations or other possibilities.

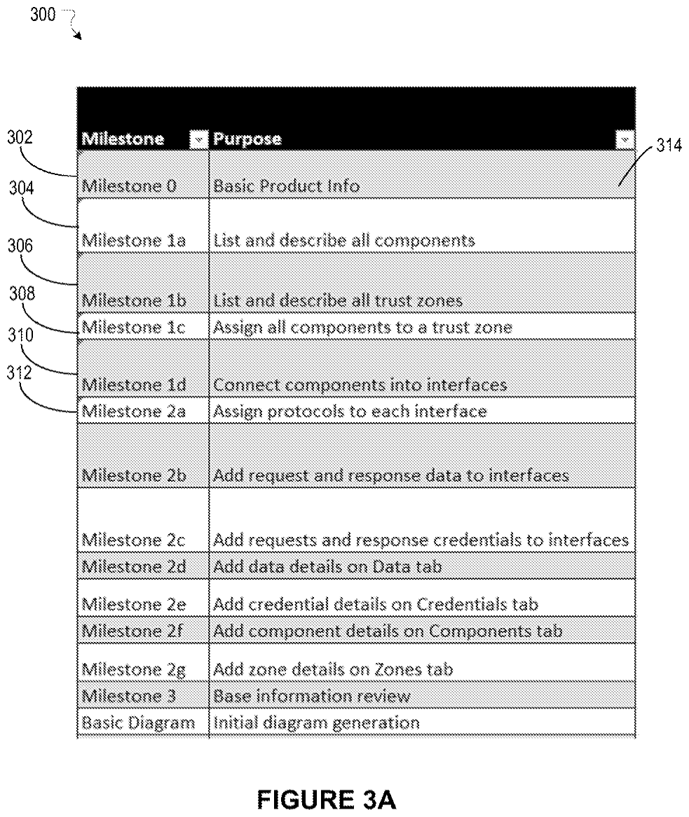

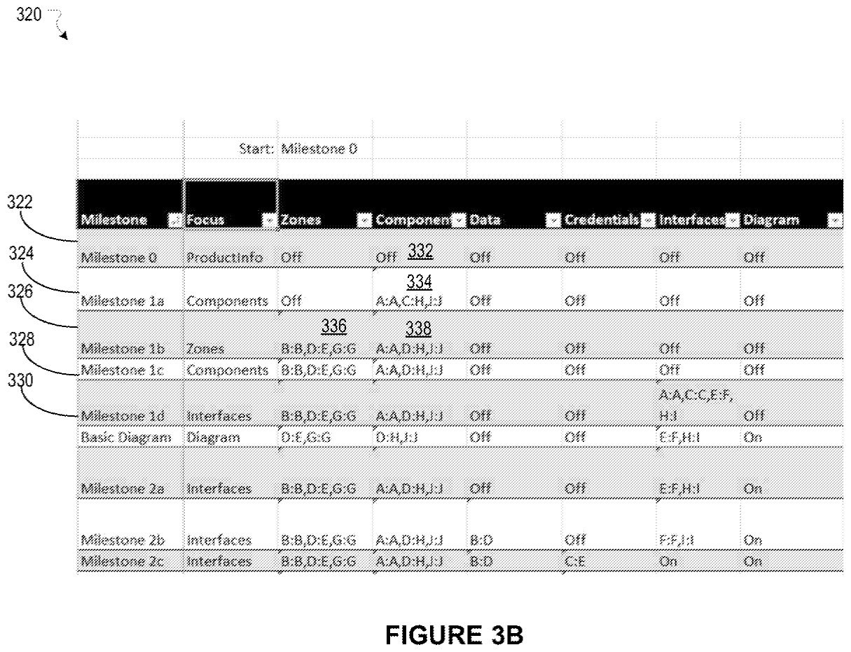

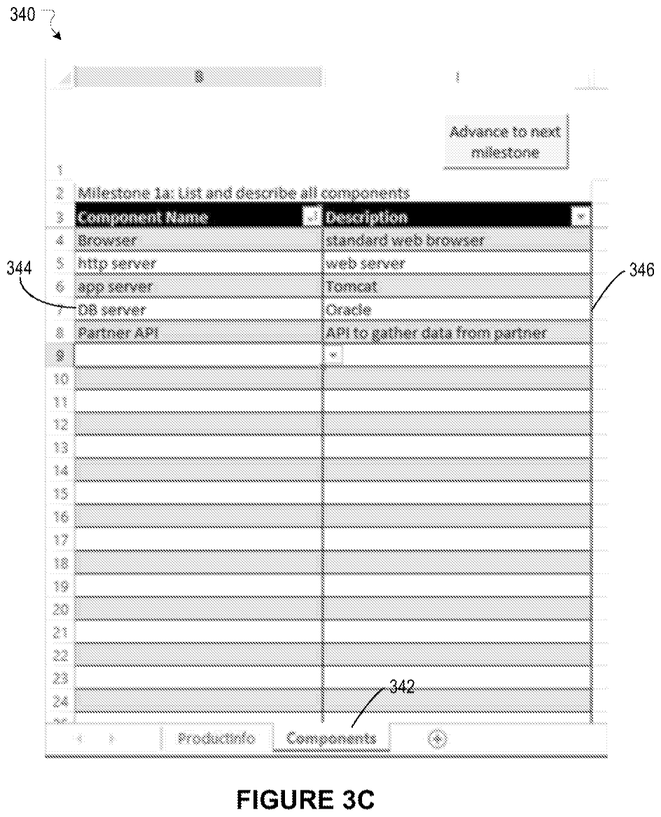

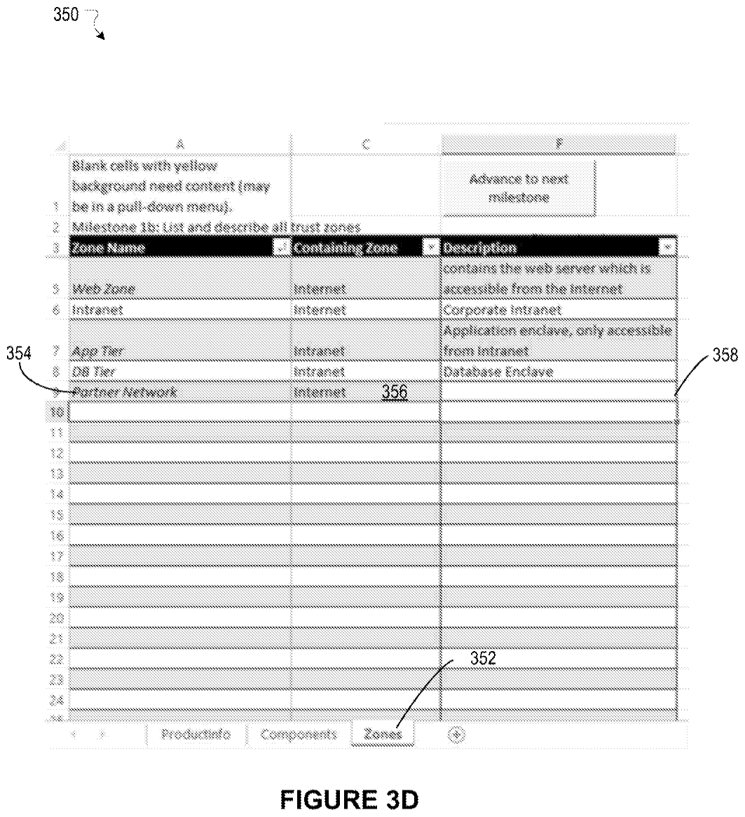

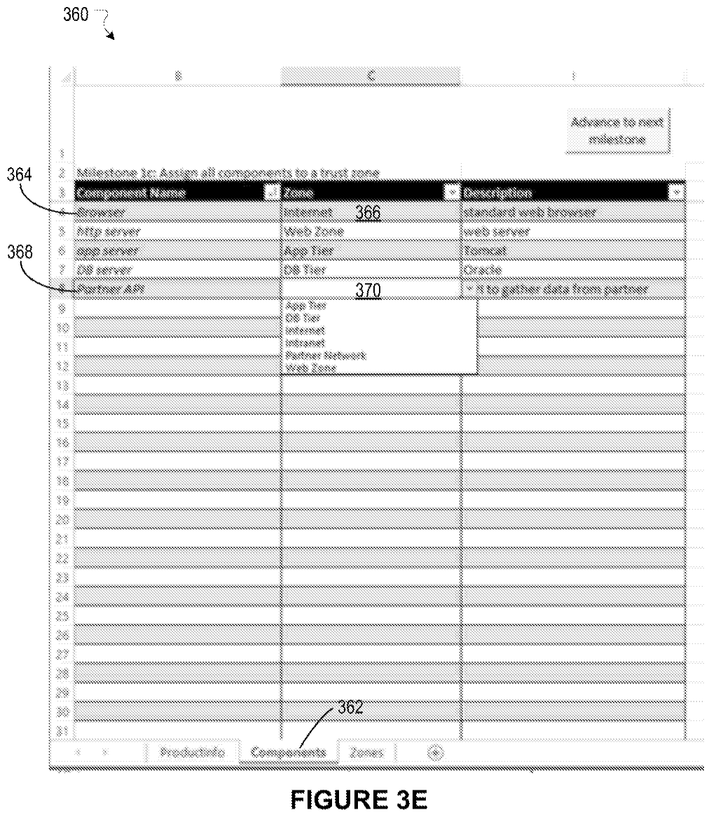

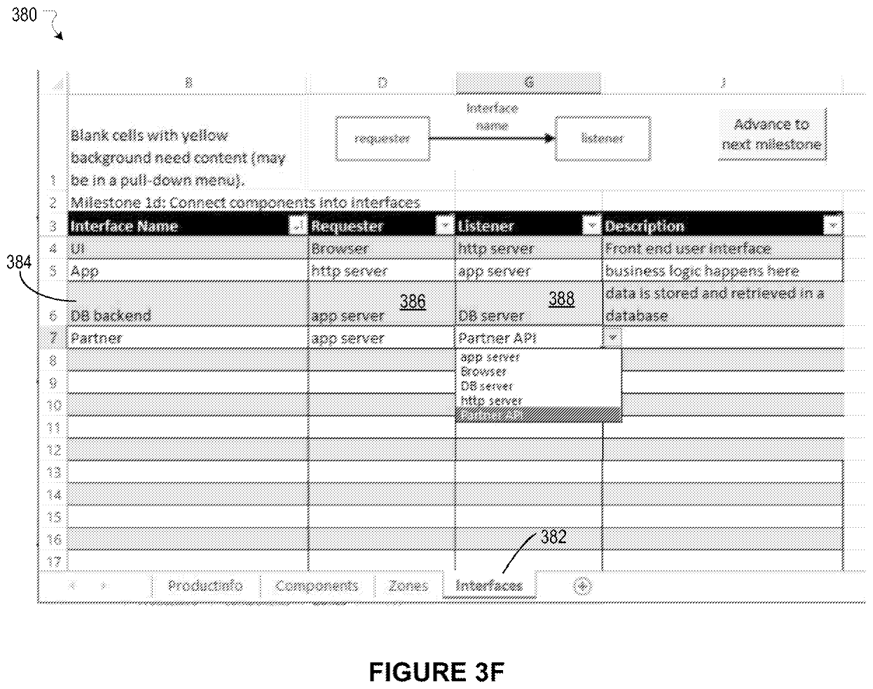

The milestone management module 112 can be configured to set up and manage milestones to facilitate gradual unfolding of data entry forms. A milestone can be associated with a data entry form defining objects and attributes of the objects. The objects and attributes can be architectural elements such as components, trust zones, interfaces, network domains, data security characteristics, or the like. For example, a first milestone can be associated with a data entry form for defining components of a system architecture. A second milestone can be associated with another data entry form for defining trust zones of the system architecture. A third milestone can be associated with yet another data entry form for associating the components defined during the first milestone and the trust zones defined during the second milestone. In some embodiments, a set of milestones can be defined using a separate data entry form, such as, for example, a spreadsheet. An example set of milestones is illustrated in FIG. 3A, which is discussed in more detail herein. Each milestone can be associated with a milestone identifier and a purpose or a goal of the milestone. In some embodiments, milestones defined in the set of milestones can be organized in an order to better illustrate a sequential nature of the milestones. The milestone management module 112 can determine progress of defining a system architecture in relation to the set of milestones. For example, the milestone management module 112 can maintain a record of and track a current milestone, previous milestone(s), and subsequent milestone(s). Many variations are possible.

The data entry module 114 can be configured to receive data entry associated with objects and attributes relating to architectural elements. The objects and attributes can include, but are not limited to, components, trust zones, network domains, interfaces, data security characteristics, or the like. In some embodiments, the data entry module 114 can provide focus to one or more data fields of a data entry form to facilitate data entry to the one or more data fields. For example, the data entry module 114 can select or highlight or otherwise enhance visibility of the one or more data fields that require data entry. In some embodiments, the data entry module 114 may differentiate mandatory data entry from optional data entry, for example, by coloring data fields differently. The data entry module 114 may notify a user of the system architecture definition module 110 of a need to provide missing data fields or a need to correct improper or conflicting data entry. In some instances, the notification may enhance visibility of the missing data fields, for example, with a highlight or with a set focus (e.g., selection of a cell of a spreadsheet). Other formatting variations can be used to indicate a missing, improper, or conflicting object or attribute. For example, a cell of a spreadsheet can be formatted distinctively to indicate the missing, improper, or conflicting object or attribute. In some instances, the notification may provide prompts with special formatting, such as a prompt “Logical error: object is associated with multiple parent trust zones that are mutually exclusive” or the like.

In some embodiments, the data entry module 114 may provide suggestions or recommendations of objects and attributes. In some embodiments, the suggestions or recommendations can be based on inferred relationships among the objects and attributes. An existence of an object may be automatically inferred based on attributes associated with the object. For example, if the data entry module 114 determines there is an interface object connecting two components “A” and “B”, then entering attributes for the interface object “A connects to B” can imply the existence of those components “A” and “B”. In some embodiments, the suggestions or recommendations can be based on one or more machine learning models trained with training data of objects and attributes, and their relationships. The machine learning models, once trained, can be used to infer whether a certain type of object is likely associated with certain attributes. For example, the data entry module 114 can suggest or recommend objects and attributes that are generally considered best candidates for enhancing security of a system architecture. Many variations are possible.

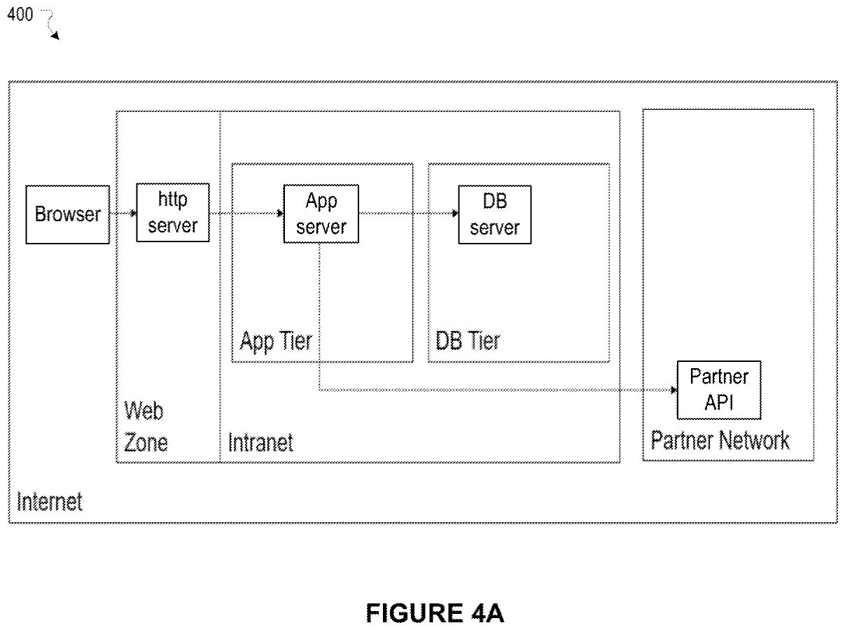

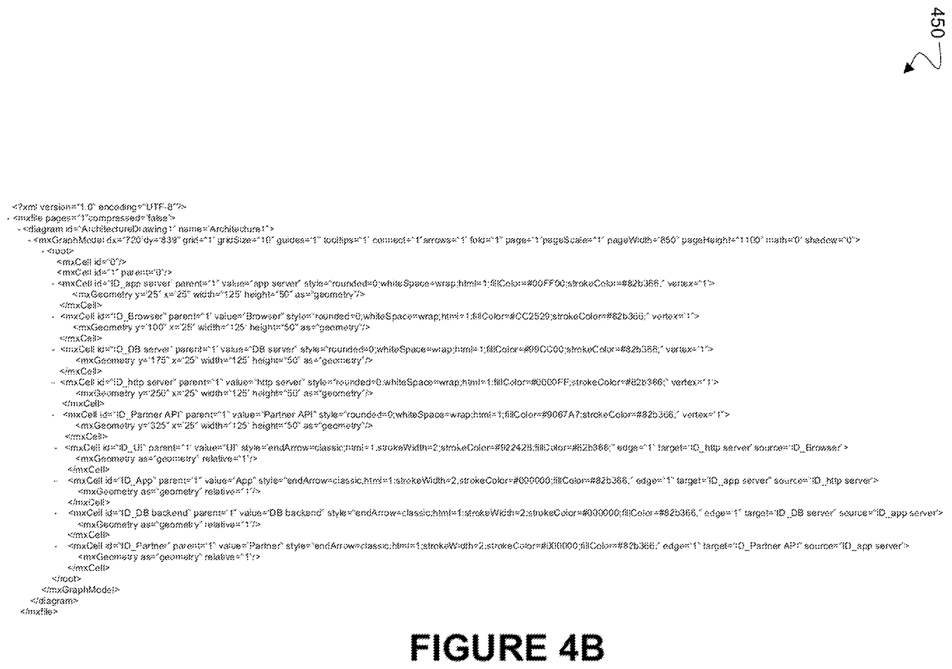

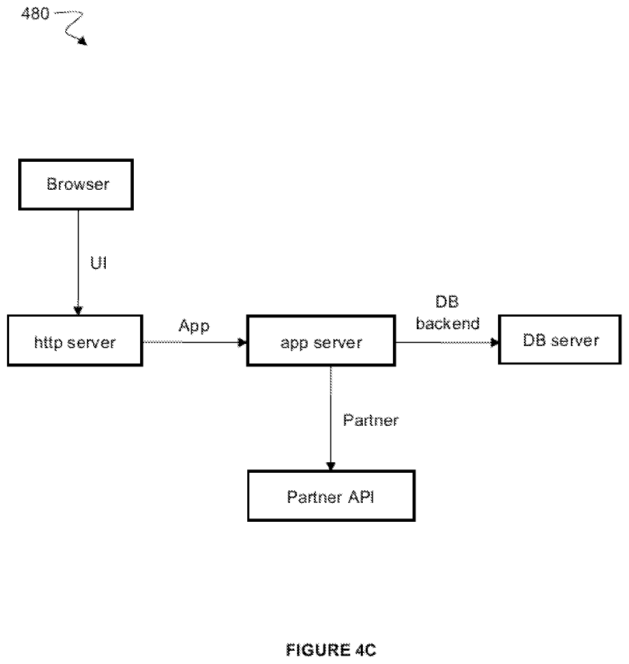

The visualization module 116 can be configured to generate a visualization of a system architecture based on data entries provided in milestones. The visualization can be a diagram describing the system architecture, such as a block diagram of the system architecture. An example visualization is illustrated in FIG. 4A, as discussed in more detail herein. In some embodiments, the visualization module 116 may generate a machine-readable description from which the visualization can be generated. For example, the visualization module 116 can generate an extensible markup language (XML) document from which the visualization can be generated. An example XML document is provided in FIG. 4B, as discussed in more detail herein. Many variations are possible.

As shown in FIG. 1, the system architecture definition module 110 can be configured to communicate with a data store 150. The data store 150 can be configured to store and maintain various types of data to support the functionality of the system architecture definition module 110. For example, the data store 150 can store milestones, states associated with the milestones including a current milestone, previous milestone(s), subsequent milestone(s), data entries, visualizations or machine-readable descriptions of visualizations, and other information used or generated by the system architecture definition module 110.

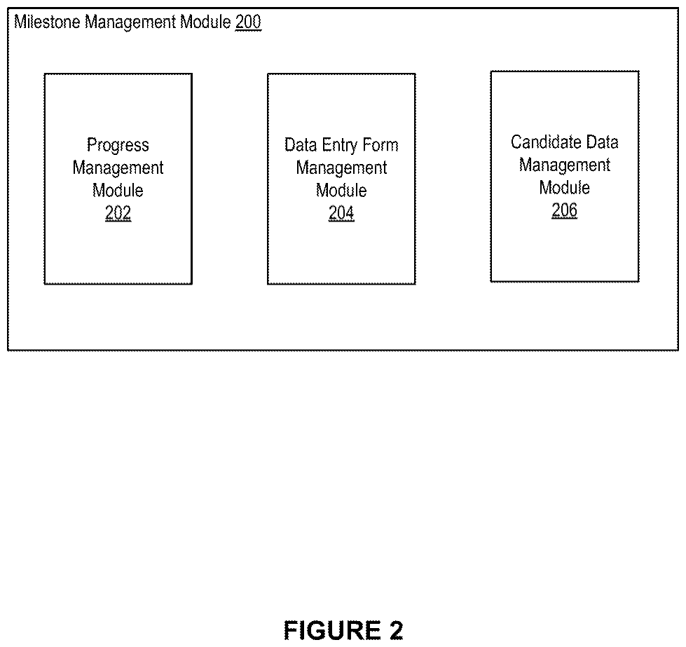

FIG. 2 illustrates an example milestone management module 200, according to an embodiment of the present technology. In some embodiments, the milestone management module 112 of FIG. 1 can be implemented as the milestone management module 200. As shown in the example of FIG. 2, the milestone management module 200 can include a progress management module 202, a data entry form management module 204, and a candidate data management module 206.

The progress management module 202 can be configured to manage a progression associated with defining a system architecture according to a set of milestones. For example, the progress management module 202 can monitor and maintain a record of a current milestone, previous milestone(s), and subsequent milestone(s). In some embodiments, the set of milestones can be managed using a table of a spreadsheet. An example set of milestones managed with a table is illustrated in FIG. 3A, which is discussed in more detail herein. Each milestone can be associated with a data entry form that unfolds (e.g., provides or makes accessible) additional data fields for data entry for the milestone. The progress management module 202 thus limits the data gathering process during the current milestone. As subsequent milestones gradually expand the data gathering process with additional data fields, users of the system architectural definition module 110 can systematically gain increasingly complex understanding of a system architecture. The progress management module 202 can provide one or more user interlaces that, when interacted with, can, for example, advance the current milestone to a subsequent milestone. In some embodiments, the progress management module 202 can communicate with the data entry module 114 and verify or validate data entries of the current milestone. When the data entries are not verified or validated, the progress management module 202 may disallow advancement to the next milestone. At completion of the data gathering process, a wholistic system architecture can emerge with all its components, trust zones, interfaces, or other architectural elements. The users of the system architectural definition module 110 can better understand each architectural element and a corresponding role or function. Thus, the users can desirably gain contextual understanding of the security impact of each architectural element of the system architecture. Many variations are possible.

The data entry form management module 204 can be configured to manage gradual unfolding of data entry forms. As described, each milestone can be associated with a data entry form and include data entry fields. Data entry fields of a milestone can receive objects or attributes of the objects relating to architectural elements. In some embodiments, the data entry form can be a spreadsheet. Some data entry fields of the milestone can be hidden or otherwise made inaccessible based on progress in relation to the milestone. In some instances, based on a milestone, the data entry form management module 202 can collapse or delete a row or column to hide or make inaccessible some data entry fields. Conversely, based on the milestone, some other data entry fields can be made visible or otherwise accessible. In some instances, the progress management module 202 can expand or insert a row or column to make visible or accessible data entry fields. The data entry form management module 204 can communicate with the progress management module 202 to determine the progress within the set of milestones and further determine and select which data fields are to be made inaccessible or accessible. The data fields to make inaccessible or accessible at each milestone can be managed based on a plan, which can be reflected in a table, chart, map, or the like. In some embodiments, the plan can be a table of a spreadsheet. An example table managing the data fields is illustrated in FIG. 3B, which is discussed in more detail herein. Many variations are possible.

The candidate data management module 206 can be configured to provide candidate data for a current milestone based on data entries of previous milestone(s). The data entries of the previous milestone(s) can become candidate data entries of a subsequent milestone. For instance, a first milestone may be associated with a first data entry form for various components of a system architecture. In this example, a second milestone may be associated with a second data entry form for various trust zones. At the first milestone, components “A”, “B”, “C”, and “D” may be provided to the first data entry form and the progress management module 202 can receive an indication that the first milestone is complete. The progress management module 202 can provide the second milestone and the second data entry form for the various trust zones. At the second milestone, trust zones, “X”, “Y”, and “Z” may be provided to the second data entry form and the progress management module 202 can receive an indication that the second milestone is complete. The progress management module 202 then can provide a third milestone with a third data entry form where each component is to be associated with at least one trust zone. The candidate data management module 206 can access the previously entered components “A”, “B”, “C”, and “D” and provide each component in, for example, a first column of the third data entry form. Further, the candidate data management module 206 can access the previously entered trust zones “X”, “Y”, and “Z” and provide each of the trust zones as selectable candidates in a second column of the third data entry form. Through selection of at least one trust zone for each component, the third data entry form can associate components with trust zones. In some instances, if the third data entry form does not provide a particular trust zone as a selectable candidate that a user of the system architecture definition module 110 desires to associate with a component, it can be determined that the second data entry form was not complete. The progress management module 202 may allow returning to the second milestone to correctly complete data entry of the second data entry form. An example data entry form associating components and trust zones is illustrated in FIG. 3E, as discussed in more detail herein. Many variations are possible.

FIGS. 3A-3F illustrate an example scenario associated with unfolding data entry forms for bi-directional learning, according to an embodiment of the present technology. FIG. 3A illustrates an example set 300 of milestones organized according to a sequential order of defining a system architecture. As described, each milestone can be associated with a milestone identifier. Each milestone can be further associated with a purpose or a goal of the milestone. For example, a first milestone 302 of “Milestone 0” is associated with a purpose 314 of defining basic product information. The set of milestones can be managed by the milestone management module 112. In the example set 300, the first milestone 302 enables data entry of basic product information, a second milestone 304 enables defining of components of the system architecture, and a third milestone 306 enables defining of trust zones. Further, in the example set 300, a fourth milestone 308 enables assigning each component defined during the second milestone 304 to at least one trust zone defined during the third milestone 308. A fifth milestone 310 enables defining or determining interfaces connecting components defined during the second milestone 304. A sixth milestone 312 enables assignment of protocols to each interface determined during the fifth milestone 310. As illustrated, milestones can be grouped into subsets of milestones (e.g., a first subset of milestones including milestones 1a 304, 1b 306, 1c 308, and 1d 310 and a second subset of milestones including at least milestone 2a 312). Any number or organization of milestones is possible.

FIG. 3B illustrates an example plan 320 for managing accessibility of data fields during each milestone. For each milestone of FIG. 3A, a plan can define which data fields are to be made accessible during the milestone. In some embodiments, the plan can define which data fields are to be made inaccessible. The example plan 320 generally defines which data fields are to be made inaccessible at each milestone. As illustrated, the example plan 320 can be a table of a spreadsheet. Each milestone can be associated with a sheet of the spreadsheet. For example, a second milestone 324 (“Milestone 1a”) can be associated with a “Components” sheet as illustrated in FIG. 3C and a third milestone 326 (“Milestone 1b”) can be associated with a “Zones” sheet as illustrated in FIG. 3D. The example plan 320 can define which sheets are to be made accessible, or made inaccessible, at a milestone according to associated conditions. For example, the first milestone 322 is associated with a first condition 332 “Off” indicating that, during the first milestone 322, the “Components” sheet is to be made inaccessible. The example plan 320 can further define which columns of data fields are to be hidden at a milestone. For example, the second milestone 324 is associated with a second condition 334 that makes columns A, C to H, and J inaccessible in the “Components” sheet (illustrated in FIG. 3C). When the progress of milestones reaches a third milestone 328 (“Milestone 1b”), the “Zones” sheet is made accessible (illustrated in FIG. 3D) according to a third condition 336 and column C is made accessible in the “Components Sheet” according to a fourth condition 338 (illustrated in FIG. 3E). Similarly, the example plan 320 can manage the accessibility of sheets and data fields available on the sheets in relation to milestone progression.

FIG. 3C illustrates a “Components” sheet 342 made accessible during the second milestone 324 according to the example plan 320. During the second milestone 324, components are defined. For example, the “Components” sheet 342 lists “Browser”, “http server”, “app server”, “DB server”, and “Partner API” components. In some embodiments, the components can be associated with descriptions to better provide context associated with the components, including the type or source of technology used. For example, a “DB server” component 344 is associated with a description 346 that it is an Oracle® technology. When the second milestone 324 is completed (e.g., data entry during the second milestone 324 is completed), the progress management module 202 may allow advancement to the next milestone, which is the third milestone 326.)

FIG. 3D illustrates a “Zones” sheet 352 made accessible during the third milestone 326 according to the example plan 320. During the third milestone 326, trust zones are defined. For example, “Zones” sheet 352 lists “Web Zone”, “Intranet”, “App Tier”, “DB Tier”, and “Partner Network” trust zones. Each trust zone can be defined in relation to its parent or child trust zones. For example, “Partner Network” trust zone 354 is contained by a parent “Internet” trust zone 356. In some embodiments, sheets can indicate which data fields need data entry as indicated by highlighted data field 358 that is missing data entry. In some instances, sheets can automatically provide focus or select one or more data fields to indicate that the data fields need data entry. When the third milestone 326 is completed, the progress management module 202 may allow advancement to the next milestone, which is the fourth milestone 328.

FIG. 3E illustrates an updated “Component” sheet 362 for the fourth milestone 328 according to the example plan 320. The fourth milestone 328 revisits the “Component” sheet 342 of the second milestone 324 illustrated in FIG. 3C. During the fourth milestone 328, the updated “Component” sheet 362 has unfolded an additional “Zone” data field. During the fourth milestone 328, components defined during the second milestone 324 can be associated with trust zones defined during the third milestone 326. For example, “Browser” component 364 can be associated with “Internet” trust zone 366 defined during the third milestone 326. The updated “Component” sheet 362 can provide candidate trust zones based on trust zone data entries made during the third milestone 326. As an example, the updated “Component” sheet 362 provides as candidates the trust zones of “App Tier”, “DB Tier”, “Internet”, “Intranet”, and “Partner Network” for association with “Partner API” component 368. In some embodiments, candidate trust zones can be inferred based on data entry. For example, “Internet” trust zone 356 was not separately defined in the first column of “Zones” sheet 352, but was defined as a parent zone for “Partner Network” trust zone 354 in FIG. 3D. The updated “Component” sheet 362 recognizes the “Internet” parent zone as another candidate trust zone and provides it as a selectable option in a dropdown user interface control 370 used to associate a trust zone with “Partner API” component 368. When the fourth milestone 328 is completed, the progress management module 202 may allow advancement to the next milestone, which is the fifth milestone 330.

FIG. 3F illustrates “Interfaces” sheet 382 made accessible during the fifth milestone 330 according to the example plan 320. During the fifth milestone 330, interfaces can be defined or determined. For example, “Interfaces” sheet 382 lists “UI” “App”, “DB backend”, and “Partner” interfaces. Each interface can be associated with a requester component and a listener component to which the interface connects. For example, “Interfaces” sheet 382 illustrates “DB backend” component 384 associated with “app server” requester 386 and “DB server” listener 388. Candidate requester and listener components can be populated based on objects and attributes defined during previous milestones. When the fifth milestone 330 is completed, the progress management module 202 may allow advancement to subsequent milestones according to the example plan 320.

FIGS. 3A-3F illustrate an example tool for unfolding data entry forms for bi-directional learning. Security experts are provided with complete views of objects and attributes associated with the objects, which results in greater understanding of overall system architecture. Product team members can incrementally learn security impact of their decisions in designing a system architecture. Each new security concept can be learned in relation to objects and attributes with which product team members are already familiarized as they have recently defined them in relationship to their project. Milestones and plans for managing the milestones can enable data-driven changes to drive a sequence of the milestones. The sequence of milestones in FIGS. 3A-3F is exemplary and not limiting. For example, a different set of milestones with a different plan for driving the different set of milestones can start with interfaces, followed by trust zones, then components. Many other variations are possible. Further, specific object types associated with a milestone in FIGS. 3A-3F are exemplary and not limiting. For example, a milestone can be associated with network domains, data security characteristics, protocols, cloud service providers, or the like.

FIG. 4A illustrates an example visualization 400 of a system architecture, according to an embodiment of the present technology. Visualizations of a system architecture can be generated by the visualization module 116. As shown, the example visualization 400 is in accordance with the example scenario illustrated in FIGS. 3A-3F. For instance, the example visualization 400 illustrates various components (e.g., “Browser”, “http server”, “app server”, “DB server”, and “Partner API”) modeled within respective trust zones (e.g., “Web Zone”, “Intranet”, “App Tier”, “DB Tier”, “Partner Network”, and “Internet”). Further, the example visualization 400 illustrates interfaces between requester components and listener components according to the example scenario.

FIG. 4B illustrates an example extensible markup language (XML) schema 450 associated with the example visualization of the system architecture of FIG. 4A, according to an embodiment of the present technology. The XML schema, or other model descriptors, can be generated by the visualization module 116. The example XML schema 450 is in accordance with the example scenario illustrated in FIGS. 3A-3F. A visualization of the example XML schema 450, such as another example visualization 480 of FIG. 4C, can be generated by an appropriate application based on the example XML schema 450. Many variations are possible.

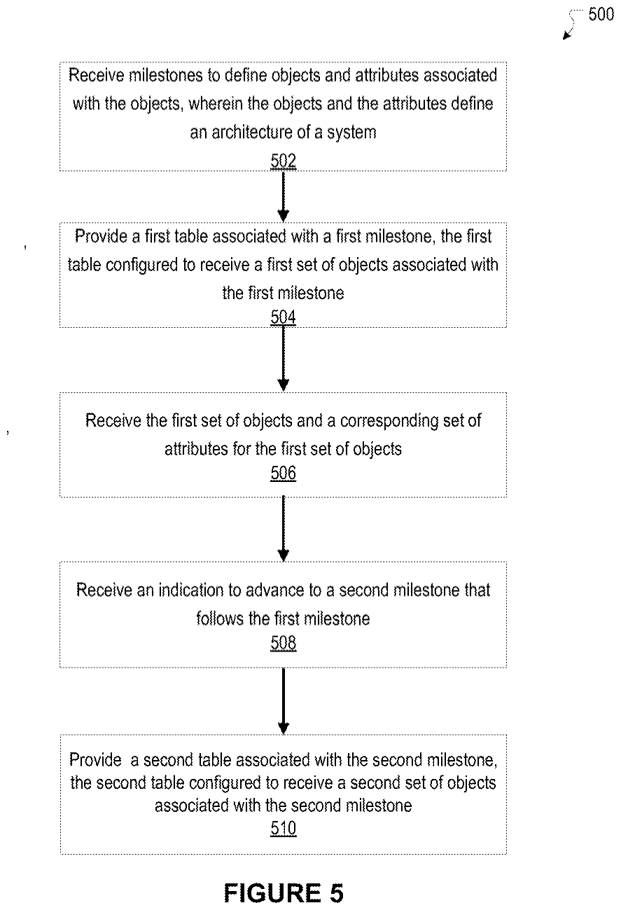

FIG. 5 a flowchart of an example method 500 associated with unfolding data entry forms for bi-directional learning, according to an embodiment of the present technology. In some embodiments, it should be understood that there can be additional, fewer, or alternative steps performed in similar or alternative orders, or in parallel, based on the various features and embodiments discussed herein unless otherwise stated.

As shown in FIG. 5, at block 502, the example method 500 can receive milestones to define objects and attributes associated with the objects. The objects and the attributes can define an architecture of a system. At block 504, the example method 500 can provide a first table associated with a first milestone, the first table configured to receive a first set of objects associated with the first milestone. At block 506, the example method 500 can receive the first set of objects and a corresponding set of attributes for the first set of objects. At block 508, the example method 500 can receive an indication to advance to a second milestone that follows the first milestone. At block 510, the example method 500 can provide a second table associated with the second milestone, the second table configured to receive a second set of objects associated with the second milestone. Many variations are possible.

### Hardware Implementation

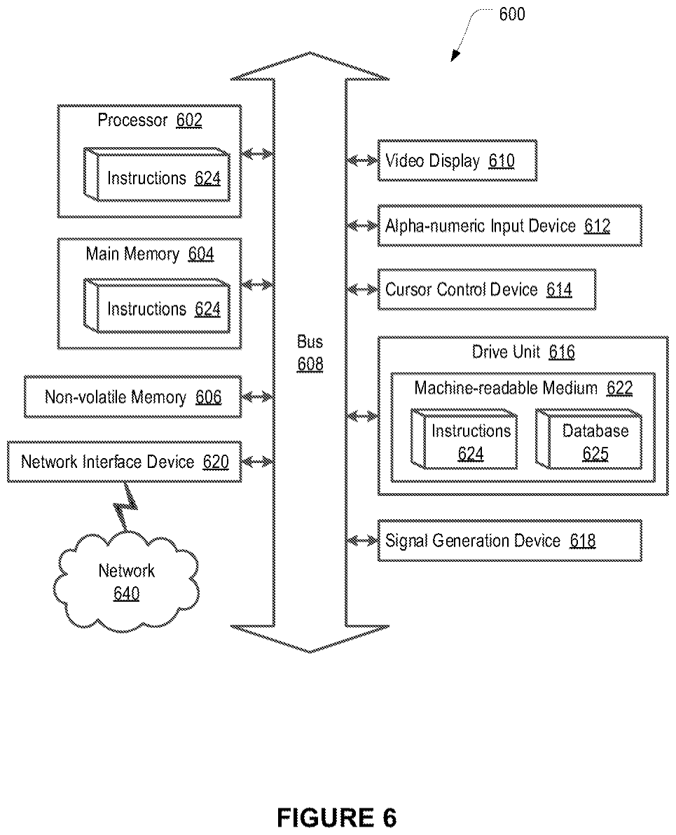

The foregoing processes and features can be implemented by a wide variety of machine and computer system architectures and in a wide variety of network and computing environments. FIG. 6 illustrates an example of a computer system 600 that may be used to implement one or more of the embodiments described herein according to an embodiment of the invention. The computer system 600 includes sets of instructions 624 for causing the computer system 600 to perform the processes and features discussed herein. The computer system 600 may be connected (e.g., networked) to other machines and/or computer systems. In a networked deployment, the computer system 600 may operate in the capacity of a server or a client machine in a client-server network environment, or as a peer machine in a peer-to-peer (or distributed) network environment.

The computer system 600 includes a processor 602 (e.g., a central processing unit (CPU), a graphics processing unit (GPU), or both), a main memory 604, and a nonvolatile memory 606 (e.g., volatile RAM and non-volatile RAM, respectively), which communicate with each other via a bus 608. In some embodiments, the computer system 600 can be a desktop computer, a laptop computer, personal digital assistant (PDA), or mobile phone, for example. In one embodiment, the computer system 600 also includes a video display 610, an alphanumeric input device 612 (e.g., a keyboard), a cursor control device 614 (e.g., a mouse), a drive unit 616, a signal generation device 618 (e.g., a speaker) and a network interface device 620.

In one embodiment, the video display 610 includes a touch sensitive screen for user input. In one embodiment, the touch sensitive screen is used instead of a keyboard and mouse. The disk drive unit 616 includes a machine-readable medium 622 on which is stored one or more sets of instructions 624 (e.g., software) embodying any one or more of the methodologies or functions described herein. The instructions 624 can also reside, completely or at least partially, within the main memory 604 and/or within the processor 602 during execution thereof by the computer system 600. The instructions 624 can further be transmitted or received over a network 640 via the network interface device 620. In some embodiments, the machine-readable medium 622 also includes a database 625.

Volatile RAM may be implemented as dynamic RAM (DRAM), which requires power continually in order to refresh or maintain the data in the memory. Nonvolatile memory is typically a magnetic hard drive, a magnetic optical drive, an optical drive (e.g., a DVD RAM), or other type of memory system that maintains data even after power is removed from the system. The non-volatile memory 606 may also be a random access memory. The non-volatile memory 606 can be a local device coupled directly to the rest of the components in the computer system 600. A non-volatile memory that is remote from the system, such as a network storage device coupled to any of the computer systems described herein through a network interface such as a modem or Ethernet interface, can also be used.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. Examples of machine-readable media (or computer-readable media) include, but are not limited to, recordable type media such as volatile and non-volatile memory devices; solid state memories; floppy and other removable disks; hard disk drives; magnetic media optical disks (e.g., Compact Disk Read-Only Memory (CD ROMS), Digital Versatile Disks (DVDs)); other similar nontransitory (or transitory), tangible (or non-tangible) storage medium; or any type of medium suitable for storing, encoding, or carrying a series of instructions for execution by the computer system 600 to perform any one or ore of the processes and features described herein.

In general, routines executed to implement the embodiments of the invention can be implemented as part of an operating system or a specific application, component, program, object, module or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 600 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually effect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in diagram form in order to avoid obscuring the description or discussed herein. In other instances, functional diagrams and flow diagrams are shown to represent data and logic flows. The components of diagrams and flow diagrams (e.g., modules, engines, s, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, “in various embodiments”, or the like means that a particular feature, design, structure, or characteristic described in connection with the embodiment is included in at least one embodiment of the disclosure. The appearances of, for example, the phrases “according to an embodiment”, “in one embodiment”, “in an embodiment”, “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, milestones to define objects and attributes associated with the objects, wherein the objects and the attributes define an architecture of a system;
providing, by the computing system, a first table associated with a first milestone. the first table configured to receive a first set of objects associated with the first milestone;
receiving, by the computing system, the first set of objects and a corresponding set of attributes for the first set of objects;
receiving, by the computing system, an indication to advance to a second milestone that follows the first milestone; and
providing, by the computing system, a second table associated with the second milestone, the second table configured to receive a second set of objects associated with the second milestone.

2. The computer-implemented method of claim 1, wherein at least one row or column in the first table is specified to be visually hidden during the first milestone.

3. The computer-implemented method of claim 2, wherein a third table specifies the first milestone, the second milestone, and the at least one row or column that is specified to be hidden during the first milestone.

4. The computer-implemented method of claim 2, further comprising:
after receiving an indication to advance to a third milestone that follows the second milestone, making the at least one row or column visible in the first table.

5. The computer-implemented method of claim 4, further comprising:
providing at least one object of the second set of objects associated with the second milestone as selectable options, wherein the selectable options are attributes that describe the first set of objects in the first table.

6. The computer-implemented method of claim 1, wherein an object of the first set of objects or the second set of objects is at least one of a component of a system, a zone in which the component is included, or an interface that connects the component to another component within the system.

7. The computer-implemented method of claim 6, further comprising:
inferring an existence of the other component based on the interface that connects the component to the other component; and
adding the other component to the first table based on the inferring the existence of the other component.

8. The computer-implemented method of claim 6, further comprising:
populating at least one attribute associated with the component based on the interface that connects the component to the other component.

9. The computer-implemented method of claim 6, further comprising:
formatting a cell of the first table to indicate a missing, improper, or conflicting object or attribute.

10. The computer-implemented method of claim 1, further comprising:
receiving an indication to generate a system diagram based on the first set of objects and the second set of objects; and
generating a visual diagram or a description of the visual diagram.

11. A system comprising:
at least one hardware processor; and
a memory storing instructions that, when executed by the at least one processor, cause the system to perform:
receiving milestones to define objects and attributes associated with the objects, wherein the objects and the attributes define an architecture of a system;
providing a first table associated with a first milestone, the first table configured to receive a first set of objects associated with the first milestone;
receiving the first set of objects and a corresponding set of attributes for the first set of objects;
receiving an indication to advance to a second milestone that follows the first milestone; and
providing a second table associated with the second milestone, the second table configured to receive a second set of objects associated with the second milestone.

12. The system of claim 11, wherein at least one row or column in the first table is specified to be visually hidden during the first milestone.

13. The system of claim 12, wherein a third table specifies the first milestone, the second milestone, and the at least one row or column that is specified to be hidden during the first milestone.

14. The system of claim 12, wherein the instructions further cause the system to perform:
after receiving an indication to advance to a third milestone that follows the second milestone, making the at least one row or column visible in the first table.

15. The system of claim 14, wherein the instructions further cause the system to perform:
providing at least one object of the second set of objects associated with the second milestone as selectable options, wherein the selectable options are attributes that describe the first set of objects in the first table.

16. A non-transitory computer readable medium including instructions that, when executed by at least one hardware processor of a computing system, cause the computing system to perform a method comprising:
receiving milestones to define objects and attributes associated with the objects, wherein the objects and the attributes define an architecture of a system;
providing a first table associated with a first milestone, the first table configured to receive a first set of objects associated with the first milestone;
receiving the first set of objects and a corresponding set of attributes for the first set of objects;
receiving an indication to advance to a second milestone that follows the first milestone; and
providing a second table associated with the second milestone, the second table configured to receive a second set of objects associated with the second milestone.

17. The non-transitory computer readable medium of claim 16, wherein at least one row or column in the first table is specified to be visually hidden during the first milestone.

18. The non-transitory computer readable medium of claim 17, wherein a third table specifies the first milestone, the second milestone, and the at least one row or column that is specified to be hidden during the first milestone.

19. The non-transitory computer readable medium of claim 17, wherein the instructions further cause the computing system to perform:
after receiving an indication to advance to a third milestone that follows the second milestone, making the at least one row or column visible in the first table.

20. The non-transitory computer readable medium of claim 19, wherein the instructions further cause the computing system to perform:
providing at least one object of the second set of objects associated with the second milestone as selectable options, wherein the selectable options are attributes that describe the first set of objects in the first table.
